(19) United States
(12) Patent Application Publication
(10) Pub. No.: US 2022/0105569 A1
(43) Pub. Date: Apr. 7, 2022

(54) Site-Specific Melt Pool Size Control in Additive Manufacturing

(71) Applicant: UT-Battelle, LLC, Oak Ridge, TN (US)

(72) Inventors: Brian T. Gibson, Knoxville, TN (US); Bradley Scott Richardson, Knoxville, TN (US); Lonnie J. Love, Knoxville, TN (US); Paritosh Mhatre, Knoxville, TN (US); Michael Borish, Knoxville, TN (US)

(21) Appl. No.: 17/478,842

(22) Filed: Sep. 17, 2021

Related U.S. Application Data
(60) Provisional application No. 63/080,207, filed on Sep. 18, 2020.

(51) Int. Cl. B22F 10/85; B33Y 10/00; B33Y 30/00; B33Y 50/02; B22F 10/28; B22F 12/90; B23K 26/03; B23K 26/06; B23K 26/342

(52) U.S. Cl. CPC B22F 10/85; B33Y 10/00; B33Y 30/00; B33Y 50/02; B22F 10/28; B23K 26/08; B23K 26/034; B23K 26/032; B23K 26/0626; B23K 26/342; B22F 12/90

(57) ABSTRACT

Closed-loop melt pool size control for additive manufacturing is integrated with site-specific changes to a controller set-point. Site-specific control enables localized control of bead geometry and material properties in an additive manufacturing system, thus offering enhanced defect mitigation capabilities when compared with constant setpoint technologies. Trigger points, generated by the projection of a secondary geometry onto a primary geometry, mark locations of the volume of a part under manufacture where site-specific changes in setpoint occur. Through this technique, it is possible to manufacture a specific geometry that occurs beyond a predefined toolpath of a print head. Implications of this capability extend beyond localized control of bead geometry to potential mitigations of defects and functional grading of component properties.

### RELATED APPLICATION

This application claims the benefit of U.S. Provisional Application No. 63/080,207, filed on Sep. 18, 2020. The entire teachings of the above application(s) are incorporated herein by reference.

### GOVERNMENT SUPPORT

This invention was made with government support under Prime Contract No. DE-AC05-00OR22725 awarded by the U.S. Department of Energy. The government has certain rights in the invention.

### COMMON OWNERSHIP UNDER JOINT RESEARCH AGREEMENT 35 U.S.C. 102(c)

The subject matter disclosed in this application was developed, and the claimed invention was made by, or on behalf of, one or more parties to a Joint Research Agreement (CRADA No. NFE-15-05725) that was in effect on or before the effective filing date of the claimed invention. The parties to the Joint Research Agreement are as follows: GKN Aerospace North America, Inc. and UT-Battelle, LLC, management and operating contractor for the Oak Ridge National Laboratory for the U.S. Department of Energy.

### BACKGROUND

Additive manufacturing is a rapidly growing field, expanding access to means of fabrication of various real-world objects, parts, or components. Such fabrication may be performed using a variety of materials, such as metal and plastic. Three-dimensional printing technology enables widespread consumer-level additive manufacturing capabilities, primarily using polymer-based materials. Industrial additive manufacturing processes often incorporate metals within materials used, taking advantage of inherently stronger physical properties of such materials, for example, despite higher costs.

### SUMMARY

Additive manufacturing systems may incorporate pre-programmed, open-loop changes to various system set points, including site-specific modifications to a real-time, closed-loop controller's set-point based on a user input. A closed-loop control system may, in turn, be established in conjunction with a programmable additive manufacturing system to modulate process parameters.

In some embodiments, a method of additive manufacturing includes receiving an input signal, which is a representation of a composite geometry that is computed as a function of a primary geometry and a secondary geometry. The secondary geometry may herein be referred to interchangeably as a “second geometry.” The method further includes producing a feedback signal as a function of a melt pool size at a given site-specific location of multiple site-specific locations of a part being manufactured by an additive manufacturing system. The part being manufactured may herein be referred to interchangeably as the “part under manufacture.”

In the foregoing embodiments, the method further includes controlling at least one of a power control parameter of a laser-equipped print head, translation rate parameter of a drive subsystem, or feedstock rate parameter of a material feed subsystem dynamically as a function of at least an actuating error signal that represents a difference between the input signal and the feedback signal to enable the additive manufacturing system to produce a customized melt pool size for the given site-specific location of the multiple site-specific locations to produce a part that, in a manufactured state, substantially matches the composite geometry.

In some embodiments, the method may include sensing a temperature of the part at a proximal location to a site-specific location, at a distal location from the site-specific location, or a combination thereof. The method may include controlling at least one of the power control parameter, translation rate parameter, or feedstock rate parameter dynamically further as a function of the temperature sensed.

In some embodiments of the method, producing the feedback signal includes capturing an image of the melt pool and extracting, from the image, a measure of at least one of size, shape, or another characteristic of a melt pool located at the site-specific location. The method may include regulating the translation rate parameter at a constant level while controlling at least one of the power control parameter or the feedstock rate parameter during translation of the print head. In some embodiments, the method may include applying non-linear control at the given site-specific location to produce a custom surface profile at the given site-specific location. The non-linear control may be applied based upon values derived from machine instructions including at least one of a lookup table, G-code representation, voxel representation, list instructions, command-line interface, or another representation.

In some embodiments, the method may include controlling the translation rate parameter to cause the drive subsystem to translate the print head with respect to the part, to translate the part with respect to the print head, or to translate both the print head and the part with respect to a common reference point or relative to each other. In some embodiments, the method may include controlling the feedstock rate parameter to cause the material feed subsystem to direct feedstock material to the part at the site-specific locations along a first and a second dimension, at a given layer defined along a third dimension. In some embodiments, the method may include computing the composite geometry based on an operation involving a first matrix describing the primary geometry and a second matrix describing the secondary geometry.

In some embodiments, an additive manufacturing system includes a laser-equipped print head configured to direct energy to a print head part, the energy of sufficient power to melt a material at site-specific locations of the part, the power adjustable via a laser power module according to a power control parameter. The system further includes a drive subsystem configured to cause a translation between the print head and the part, the translation adjustable according to a translation rate parameter. The system further includes a material feed subsystem configured to direct feedstock material to the part at the site-specific locations to be irradiated by the directed energy of the laser-equipped print head, the feedstock material output adjustable according to a feedstock rate parameter. The system further includes a closed-loop feedback control subsystem including a comparison unit, controller, and melt pool size sensor.

In the foregoing embodiments, the comparison unit is configured to receive an input signal that is a representation of a composite geometry of a primary geometry and a secondary geometry that the part is to match substantially in a manufactured state at least at one or more site-specific locations. The comparison unit is further configured to receive a feedback signal provided by the melt pool sensor that is a function of a measure of size, shape, or another characteristic of a melt pool located at a given site-specific location.

In the foregoing embodiments, the comparison unit is further configured to output an actuating error signal that represents a difference between the input signal and the feedback signal. The controller is configured to control at least one of the power control parameter, translation rate parameter, or feedstock rate parameter dynamically as a function of the actuating error signal to enable the additive manufacturing system to produce a customized melt pool size, shape, or feature for the given site-specific location of the multiple site-specific locations to produce the part such that the part, in a manufactured state, substantially matches the composite geometry.

In some embodiments, the system includes at least one additional sensor configured to sense a temperature of the part at a proximal location to a site-specific location, at a distal location from the site-specific location, or at a combination thereof. The at least one additional sensor may be configured to provide a respective sensor signal according to a temperature sensed by the at least one additional sensor. The controller may be configured to receive the respective sensor signal. The controller may be configured to control at least one of the power control parameters, translation rate parameter, or feedstock rate parameter dynamically further as a function of the temperature sensed.

In some embodiments, the melt pool sensor includes a thermal or visible light camera, or a combination thereof. In some embodiments, the secondary geometry is one of multiple secondary geometries. In some embodiments, the controller is configured to regulate the translation rate parameter at a constant level while controlling at least one of the power control parameter or the feedstock rate parameter during translation of the print head. In some embodiments, the controller is configured to apply non-linear control at the given site-specific location to produce a custom surface profile at the given site-specific location. The non-linear control may be applied based upon values derived from machine instructions including at least one of a lookup table, a G-code representation, a voxel representation, list instructions, a command-line interface, or another representation.

In some embodiments, the drive subsystem is configured to cause a translation between the print head and the part by translating the print head with respect to the part, by translating the part with respect to the print head, or by translating both the print head and the part with respect to a common reference point or relative to each other. In some embodiments, the material feed subsystem is configured to direct feedstock material to the part at the site-specific locations along a first and second dimension at a given layer defined along a third dimension. In some embodiments, the controller resides in a feedback loop between an output node of the comparison unit and an input node of at least one of the laser power module, the drive subsystem, or the material feed subsystem. In some embodiments, the system includes a composite geometry calculation module configured to calculate the composite geometry based on an operation involving a first matrix describing the primary geometry and a second matrix describing the secondary geometry and to output the composite geometry as a representation thereof to the comparison unit.

In some embodiments, a system for site-specific, closed-loop melt pool size control in metal additive manufacturing includes a laser-based print head configured to manufacture metal objects in an additive fashion. The system further includes a holder for holding a metal object while it is being manufactured using the laser-based print head. The system further includes a camera to image, in real-time, a melt pool on an instant surface of the metal object while it is being manufactured. The system further includes a controller configured to perform operations for a plurality of sites of the instant surface of the metal object.

The operations of the foregoing embodiments include obtaining an indication of a current site of the plurality of sites, the melt pool occupying at least a portion of a surface of the current site, with the depth of the melt pool being a function of input for the site-specific location. The operations further include accessing a predetermined mapping of target laser-power levels to sites of the instant surface to establish a target laser-power level for the current site. The operations further include obtaining an instant laser-power level and comparing it with the target laser-power level for the current site. If the instant and target laser-power levels differ from each other by more than a predetermined power constant, the operations further include setting the laser-power level to the target laser-power level for the current site.

The operations of the foregoing embodiments further include accessing a predetermined mapping of target melt pool sizes to sites of the instant surface to establish a target melt pool size for the current site. The operations further include (i) receiving images of the melt pool from the thermal camera, (ii) determining, based on the received images of the melt pool, an instant melt pool size, and (iii) comparing at least one dimension represented therein with the target melt pool for the current site. If the instant and target melt pool sizes differ from each other by more than a predetermined size offset, the operations further include adjusting the laser-power level for the current site to a level corresponding to the target melt pool size. Site-specific locations may herein be referred to interchangeably as “sites.”

In some embodiments, the predetermined mapping of target laser-power levels to sites of the instant surface may be based on at least one of a lookup table, a G-code representation, a voxel representation, list instructions, a command-line interface, or another representation. In some embodiments, the predetermined mapping of target melt pool sizes to sites of the instant surface may be based on at least one of a lookup table, a G-code representation, a voxel representation, with instructions, or a command-line interface. In some embodiments, the system may be further configured to emboss a secondary geometry on a primary geometry of the metal part. In some embodiments, the system may be further configured for metal big-area additive manufacturing.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIGS. 1A-L are schematic block diagrams showing various aspects of an additive manufacturing system.

FIG. 2A is a schematic block diagram showing the overall operation of the additive manufacturing system.

FIG. 2B is a schematic block diagram showing the overall operation of the additive manufacturing system including additional features.

FIG. 3 is a three-dimensional representation of geometries to be used as inputs to the additive manufacturing system.

FIG. 4 is a three-dimensional representation of a primary geometry to be used as an input to the additive manufacturing system.

FIG. 5A is a sketch of a secondary geometry to be used as an input to the additive manufacturing system.

FIG. 5B is a depiction of a segmentation the secondary geometry of FIG. 5A.

FIG. 5C is a plot showing trigger points generated from the segmented image of FIG. 5B.

FIGS. 6A-E are example thermal images of a melt pool on a part under manufacture by the additive manufacturing system.

FIG. 7 is a three-dimensional plot showing the addition of a secondary geometry to a primary geometry toolpath of the additive manufacturing system.

FIGS. 8A-B are plots showing system response to set-point step commands of the part under manufacture.

FIG. 9 is a plot showing response time of a size of a melt pool of a part under manufacture in the additive manufacturing system.

FIGS. 10A-D are photographs showing effects of changing a melt pool size on a part under manufacture in the additive manufacturing system.

FIGS. 11A-B are thickness plots for sides of walls of a part under manufacture in the additive manufacturing system.

FIGS. 12A-B are photographs of a part constructed by the additive manufacturing system.

FIG. 13A is a plot showing a primary geometry and a bounding box defining a secondary geometry to be used as inputs to the additive manufacturing system.

FIG. 13B is a photograph of a part constructed by the additive manufacturing system using site-specific control.

FIG. 13C is a photograph of a part constructed by the additive manufacturing system wherein site-specific control was not used.

### DETAILED DESCRIPTION

A description of example embodiments follows.

Additive manufacturing systems may incorporate pre-programmed, open-loop changes to various system set points, including site-specific modifications to a real-time, closed-loop controller's set-point based on a user input. Such user inputs may include, for example, a secondary geometry to be embossed upon a part otherwise manufactured according to a primary geometry.

Various conditions, however, such as temperature across a part under manufacture by an additive manufacturing system, may not remain consistent. Such inconsistencies at the part under manufacture may cause attributes of the part to drift away from those expected or intended based on the pre-programmed set points, resulting in a malformed or otherwise poorly made part. A closed-loop control system may thus be established in conjunction with a programmable additive manufacturing system to modulate process parameters to control a characteristic of the manufacturing process to respond to perceived (i.e., sensed) variations in measured parameters across the part under manufacture, thus promoting a closer adherence to an intended design profile for the part.

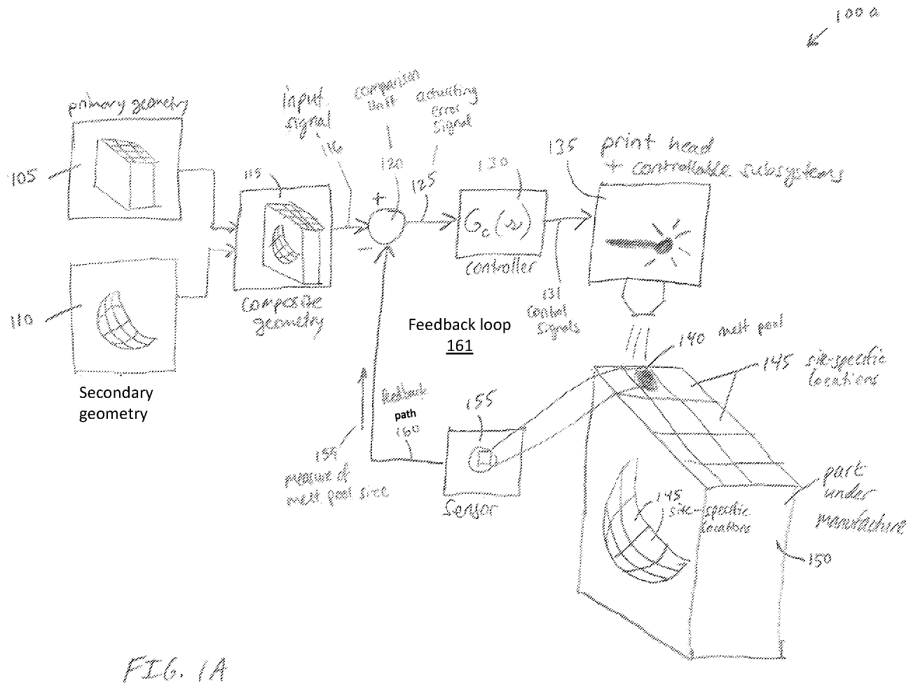

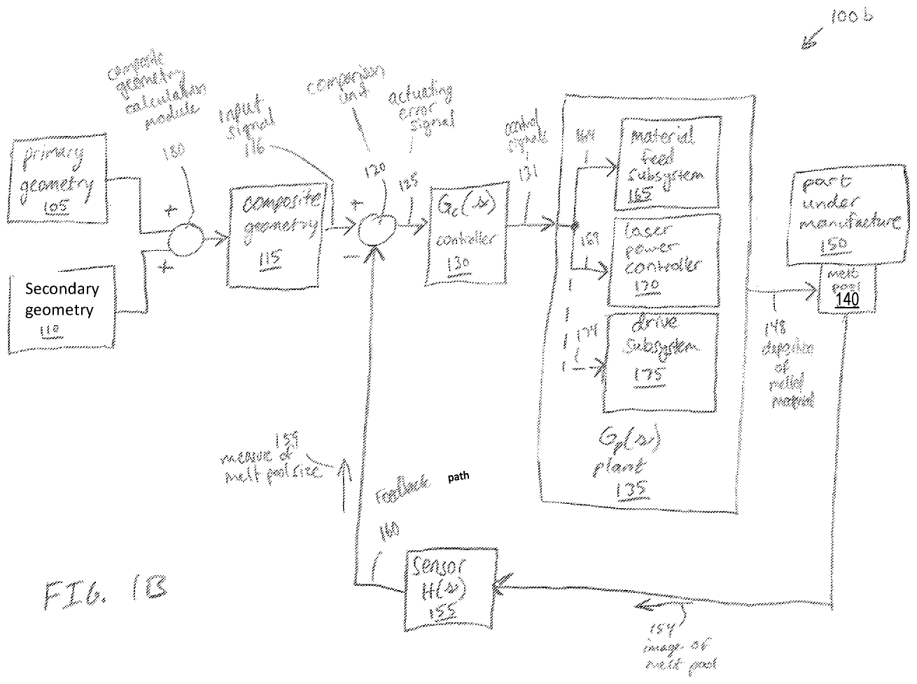

FIG. 1A is a high-level depiction of an additive manufacturing system 100a configured to use site-specific closed-loop control according to an example embodiment of the present invention. In some embodiments, a representation of a primary geometry 105 is combined with a representation of a secondary geometry 110 to form a representation of a composite geometry 115. In some embodiments, the secondary geometry 110 may be a two-dimensional or three-dimensional secondary geometry. The secondary geometry 110 may be herein interchangeably referred to as a “second geometry” 110. An input signal 116 carries a representation of the composite geometry 115 to a comparison unit 120 of the additive manufacturing system 100a.

It should be understood, in regard to FIG. 1A, that data storage (not shown) for the primary geometry 105, secondary geometry 110, and composite geometry 115, or a processor to compose the composite geometry 115, may be integrated in the additive manufacturing system 100a, or be distinct from the system 100a.

In the embodiment of FIG. 1A, the additive manufacturing system 100a includes a comparison unit 120 configured to compare the input signal 116 (representing the composite geometry 115) with a feedback signal 159 (representing a measure of melt pool size, i.e., at least one dimension of a melt pool at a site-specific location, and propagating via a feedback path 160) to produce an actuating error signal 125. A controller 130 is configured to accept the actuating error signal 125 as an input and to produce control signals 131 therefrom. The control signals 131 are transmitted to a print head and controllable subsystems 135. The print head and controllable subsystems 135 is represented by a transfer function G_{P}(s). The print head and controllable subsystems 135 may be referred to as the plant of a control system employed by the additive manufacturing system 100a.

The print head and controllable subsystems 135 of FIG. 1A produce a melt pool 140 at a site-specific location of the plurality of site-specific locations 145 of a part under manufacture 150. The part under manufacture 150 may herein be referred to interchangeably as the “part being manufactured,” “manufactured part,” or as the “component under construction.” The site-specific locations 145 may refer to regions of the part under manufacture 150 corresponding to either the primary geometry 105 or the secondary geometry 110, possibly including locations of unique topography of the composite geometry 115. The sensor 155 may be used to sense the melt pool 140. The sensor 155 may be a camera. The camera may be a thermal camera. The sensing of the melt pool 140 may include taking an image of the melt pool. The sensing of the melt pool 140 may include determining a size of the melt pool. The sensor 155 may produce a feedback signal 159 as a function of a size of the melt pool. The feedback signal 159 may be a measure of a dimension of the melt pool size.

The measure of the dimension of the melt pool size of FIG. 1A may be determined by embedded or locally connected hardware or software associated with the sensor 155. The measure of the melt pool size may thus be propagated along the feedback path 160. Alternatively, the feedback signal 159 may include an image of the melt pool, or a representation thereof, from which the melt pool size may be extracted by a component that, aside from the feedback path 160, may be otherwise separate, and possibly located remotely, from the sensor 155. Some embodiments of a system 100a may include a feedback loop 161 connecting various elements including the comparison unit 120, controller 130, print head and controllable subsystems 135, part under manufacture 150, and sensor 155. In some embodiments, the controller 135 may reside in the feedback loop 161 between an output node of the comparison unit 120 and an input node of the print head and controllable subsystems 135.

Some embodiments of additive manufacturing systems thus employ two aspects in tandem: site-specific parameter modifications and closed-loop control. In some embodiments, an additive manufacturing system 100a is programmed to print or otherwise manufacture a part 150 according to a specific three-dimensional geometry that is not part of the print head's toolpath, i.e., an extra-toolpath geometry. The extra-toolpath geometry may be defined or suggested by a secondary geometry 110 or a representation thereof, while the print head's toolpath may be defined or suggested by a primary geometry 105 or a representation thereof. Such an additive manufacturing system 100a may generate trigger points as inputs at which various set points are changed in order to incorporate features of the extra-toolpath geometry. The set points may relate to a molten pool of material, such as metal, or a size thereof. The molten pool of material may be referred to herein as a “melt pool” 140. The melt pool 140 may be present at an active surface of a part under manufacture 150. An active surface may be considered any surface of the part under manufacture 150 to which a deposition of material is being made or to which the additive manufacturing system 100a is presently programmed to make a deposition of material.

Some embodiments of additive manufacturing systems 100a, including some embodiments programmed to print according to an extra-toolpath geometry, exhibit a phenomenon wherein the magnitude of laser power required to achieve consistent embossing may change depending on thermal properties of the part under manufacture. Therefore, in some embodiments, a controller uses a sensor 155, such as a thermal camera, to detect a melt pool 140 and to measure a size thereof. In some embodiments, a software-based controller 130 automatically adjusts set points related to melt pool size, such as a laser power control parameter, a feedstock rate parameter, and a translation rate parameter of a physical drive subsystem, to achieve a desired melt pool size. Such adjustments may be applied at any layer of a plurality of layers of a part under manufacture 150.

In some embodiments, a laser hot-wire directed-energy deposition (DED) process may be used to print manufactured parts 150 from, for example, a Ti-6Al-4V feedstock material. In some embodiments, printed Titanium components may be deposited in a custom, large-scale laser-hot wire DED workcell. The workcell may contain a 6-axis industrial robot, wirefeeder, hot-wire system, and may be supplied by one or more fiber-delivered diode lasers. In embodiments including multiple such lasers, power from multiple lasers may be combined into a single fiber to increase the total laser power available to irradiate a site-specific location 145 of a manufactured part 150. In addition to laser optics, a print head 135 may contain in-axis or off-axis process and thermal cameras as well as other sensors 155. The sensors 155 may receive emissions from the melt pool 140 that are transmitted through a dichroic mirror in the laser optics. The process camera may be used to monitor process stability and identify process interruptions, such as an improper wire input location or unstable wirefeed behavior. The thermal camera may be used to image the melt pool 140 and generate a thermal field, which may then be processed to generate a melt pool size definition in real-time. Such a generated definition of melt pool size is low-noise, which is desirable from a control system perspective. Such a generated definition may also consistently track with the thermal properties of the build (i.e., manufactured part 150).

FIG. 1B is a block diagram showing an overall operation of an additive manufacturing system 100b configured to use site-specific closed-loop control. A composite geometry calculation module 180 of the system 100b may include a processor configured to compose a representation of the composite geometry 115. The composite geometry calculation module 180 may be referred to as a “slicer.” The slicer may comprise software instructions that, when executed by the processor, slice a CAD model of the part under manufacture 150 into layers. Execution of the software instructions may generate a toolpath for each layer. The primary geometry 105 may include the generated toolpaths. Execution of the software instructions may generate site-specific parameters by producing the representation of the composite geometry 115 based on a combination of the secondary geometry 110 with the primary geometry 105. The composite geometry 115 may be represented by an input signal 116 to be transmitted to a comparison unit 120 of the additive manufacturing system 100b.

In the embodiment of FIG. 1B, the comparison unit 120 is configured to produce an actuating error signal 125 by comparing the composite geometry 115 with a feedback signal 159, which feedback signal 159 may include a measure of melt pool size of a part under manufacture 150. A controller 130 is configured to accept the actuating error signal 125 as an input and produce control signals 131 as outputs therefrom. The control signals 131 may include a signal to control a feedstock rate parameter 164 of a material feed subsystem 165, signals to control a power control parameter 169 of a laser-power controller 170, or signals to control a translation rate parameter 174 of a drive subsystem 175. A system plant 135, represented by transfer function G_{P}(s), may include the material feed subsystem 165, the laser power controller 170, and the drive subsystem 175. The plant 135 may be configured to cause deposition of melted feedstock material 148 at a melt pool 140 of the part under manufacturer 150. An image 154 of the melt pool 140 may be taken by a sensor 155. The sensor 155 may produce a feedback signal 159 to travel along a feedback path 160. The feedback signal 159 is transmitted to the comparison unit 120 to be used to calculate the actuating error signal 125.

FIG. 1C is a schematic diagram of an input side 100c of an additive manufacturing system. In some embodiments, a primary geometry 105 and a secondary geometry 110 are combined by a composite geometry calculation module 180 to form a composite geometry 115. A comparison unit 120 is configured to compare a representation of the composite geometry 115 with information from a feedback signal 159 to calculate an actuating error signal 125. The actuating error signal 125 is transmitted to a controller 130 which controller 130 then produces control signals 131. The composite geometry calculation module 180 may be implemented in an optional computer 185. The comparison unit 120 may be implemented in an optional computer 185. The controller 130 may be implemented in the optional computer 185. In some embodiments, the composite geometry calculation module 180, the comparison unit 120, and/or the controller 130, or any combination thereof, may be implemented in an optional computer 185, or maybe implemented as standalone or combined units.

FIG. 1D is a schematic diagram showing an output side 100d of an additive manufacturing system. The control signals 131 from FIG. 1C can be seen at point A coming from FIG. 1C. The control signals 131 may include a signal to control a feedstock rate parameter 164 of a material feed subsystem 165, signals to control a power control parameter 169 of a laser power controller 170 of a print head 190 for additive manufacturing, or signals for controlling a translation rate parameter 174 of the drive subsystem 175, or any combination thereof. The drive subsystem 175, in some embodiments, may comprise multiple drive subsystems, such as a first drive subsystem 175-1 for translating the print head 190 with respect to the part under manufacture 150. In some embodiments, the drive subsystem 175 may include a second drive subsystem 175-2 for translating the part under manufacture 150 with respect to the print head 190. In some embodiments, the first drive subsystem 175-1 and the second drive subsystem system 175-2 may function simultaneously such that both the print head 190 and the part 150 may be translated simultaneously with respect to a common reference point or relative to each other. In some embodiments, a first translation rate parameter 174-1 may be used to control the first drive subsystem 175-1 and a second translation rate parameter 174-2 may be used to control the second drive subsystem 175-2. In some embodiments, the translation rate parameter 174, 174-1, 174-2 may be regulated at a constant level while at least one of the power control parameter 169 or the feedstock rate parameter 164 is controlled during translation of the print head 190. Translation rate parameters 174, 174-1, and 174-2 are therefore shown in the diagrams of FIG. 1C and FIG. 1D as occurring along dotted lines. In some embodiments, the first drive subsystem 175-1 may be configured to translate the print head 190 in any of three dimensions or any combination thereof as shown by directions labeled as x₁, y₁ and z₁ on a set of axes of motion of the print head. In some embodiments, the second drive subsystem 175-2 may be configured to translate the part under manufacture 150 in any one of three dimensions or any combination thereof as shown by directions x₂, y₂ and z₂ on a set of axes of motion of the part. In some embodiments, the print head 190 may be a laser enabled print head having a laser 195 for irradiating feedstock material 167. In some embodiments, the feedstock material 167 may be in rod form or wire form. In some embodiments, the laser enabled print head 190 may be configured to deposit melted material 148 upon a melt pool 140 of the part under manufacture 150 at a site-specific location of site specific locations 145 of the part under manufacture 150. The site-specific locations 145 may correspond to locations of primary geometry 105, the secondary geometry 110, or a combination thereof such as the composite geometry 115. In some embodiments, a sensor 155 may be configured to sense the melt pool 140. In some embodiments, the sensor 155 may be, for example, a camera which may be, for example, a thermal camera. In some embodiments, the sensor 155 may produce a feedback signal 159. The feedback signal 159 may carry a representation of a melt pool size which may be a measure of the melt pool size. A feedback path 160 may be seen returning to FIG. 1C at point B.

FIG. 1E is a schematic diagram of a system 100e for additive manufacturing including a sensor 155 configured to sense a part under manufacture 150. The sensor 155 may be configured to sense a parameter of the part under manufacture 150 such as temperature 157. The temperature sensed 157 may be configured to be transmitted to a controller 130 which may be configured to produce control signals 131 to control at least one of a material feed subsystem 165, a laser-power controller 170, or a drive subsystem 175, which may include a first 175-1 and a second 175-2 drive subsystem.

FIG. 1F is a schematic diagram of a system 100f for additive manufacturing. In some embodiments, a sensor 155 may be a camera such as thermal camera, and may be configured to sense a melt pool 140 of a manufacture 150. The sensor 155 may be configured to produce an image 154 of melt pool 140. The image 154 may for example be a thermal image. Through a measurement, a measure of melt pool size 159f may be extracted from image 154 of the melt pool 140. The measure of the melt pool size 159f may be extracted by hardware and/or software embedded or locally connected with the sensor 155, in which case a feedback signal 159 includes the measure of melt pool size 159f. Alternatively, the measure of the melt pool size 159f may be extracted by hardware and/or software resident to a device such as a computer that, aside from being connected to the sensor 155 via the feedback path 160, may be otherwise separate from the sensor 155, in which case a feedback signal 159 includes the image of the melt pool 154.

FIG. 1G is a schematic diagram of a portion 100g of a system for additive manufacturing. A controller 130 may be configured to apply non-linear control at a given site-specific location of site-specific locations 145 of a part under manufacture 150 to produce a custom surface profile at the given site-specific location 145. The nonlinear control may be applied based upon values derived from machine instructions including at least one of a lookup table 132, a G-code representation, a voxel representation, list instructions, or a command-line interface. In some embodiments, the machine instructions may be transmitted to the controller 130, or the machine instructions may reside locally to the controller 130.

FIG. 1H is a schematic diagram of a portion of 100h of a system for additive manufacturing. In some embodiments, a controller 130 may be configured to produce a control signal 131 that includes signals to control the translation rate parameter 174 to cause the drive subsystem 175 to translate the print head 190 with respect to the part 150 by actuating the first drive subsystem is 175-1 or to translate the part 150 with respect to the print head 190 by actuating the second drive subsystem 175-2. In some embodiments, the print head 190 and part 150 may similarly be translated with respect to a common reference point or relative to each other.

FIG. 1I is a schematic diagram of a portion 100i of a system for additive manufacturing. In some embodiments, a controller 130 may be configured to produce control signals 131 including signals to control a feedstock rate parameter 164 of a material feed subsystem 165 to direct feedstock material 167 to the part 150 at site-specific locations 145 along a first and a second dimension in a given layer 146 defined along a third dimension.

FIG. 1J is a schematic diagram of a portion 100j of a system for additive manufacturing. In some embodiments, a composite geometry calculation module 180 may be configured to compute a composite geometry 115 based on an operation involving a first matrix 117 describing the primary geometry 105 and a second matrix 118 describing the secondary geometry 110. In some embodiments, the matrices 117, 118 may be configured as a lookup table 132 to be transmitted to the controller 130 to be used in determining control signals 131 to control various aspects of the plant 135 of the control system of the additive manufacturing system.

FIG. 1K is a schematic diagram of a portion 100k of a system for additive manufacturing. In some embodiments, the sensor 155 may include at least a first sensor 155-1 and a second sensor 155-2, the at least two sensors mutually or separately configured to sense respective site-specific locations 145, or respective features at the same location, of a part under manufacture 150. Such respective site-specific locations 145, or features, may be at a proximal location to the site-specific location of the melt pool 140 or at a distal location from the site-specific location of the melt pool 140, or a combination thereof. In some embodiments, the first sensor 155-1 and the second sensor 155-2 may be configured to sense the temperature of the part 150 at any of the various site-specific locations 145.

FIG. 1L is a schematic diagram of a portion 100l of a system for additive manufacturing. In some embodiments, a composite geometry calculation module 180 may be configured to accept, as inputs, a primary geometry 105 and multiple secondary geometries 110 such as at least a first secondary geometry 110-1 and a secondary geometry 110-2.

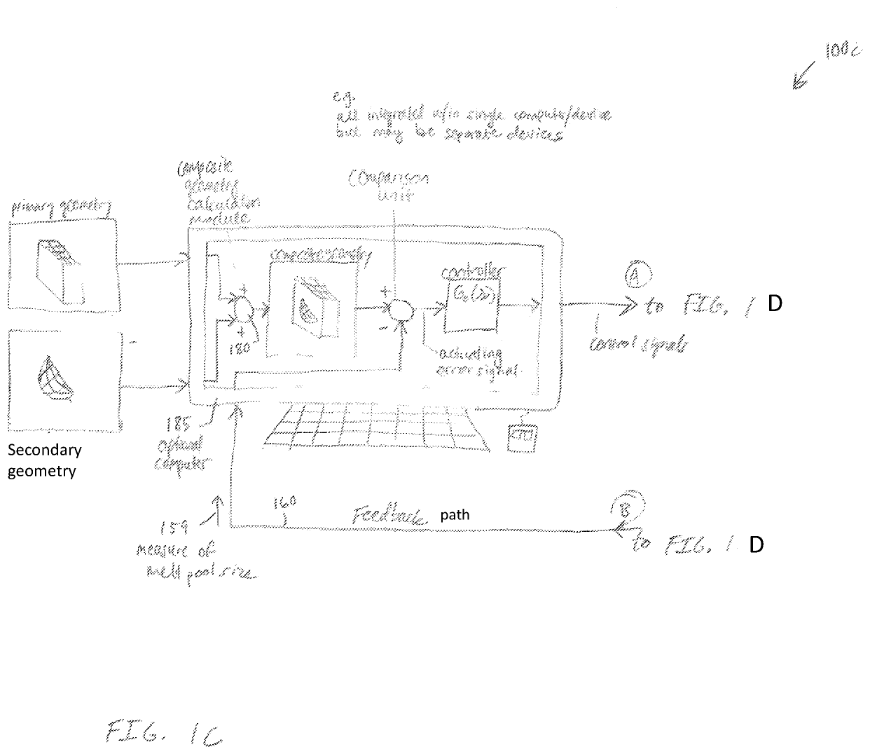

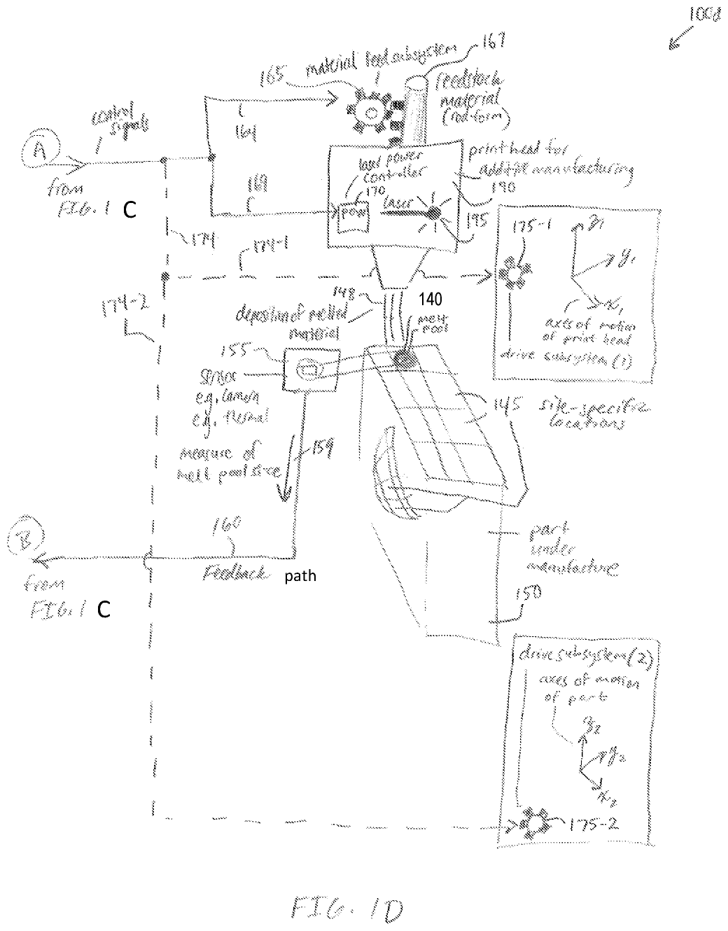

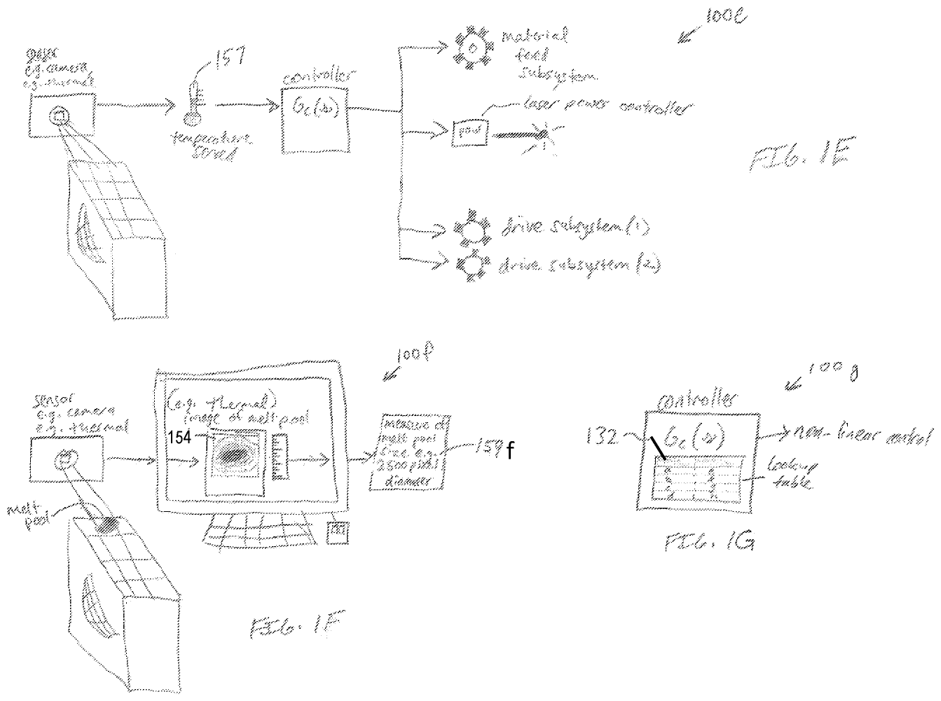

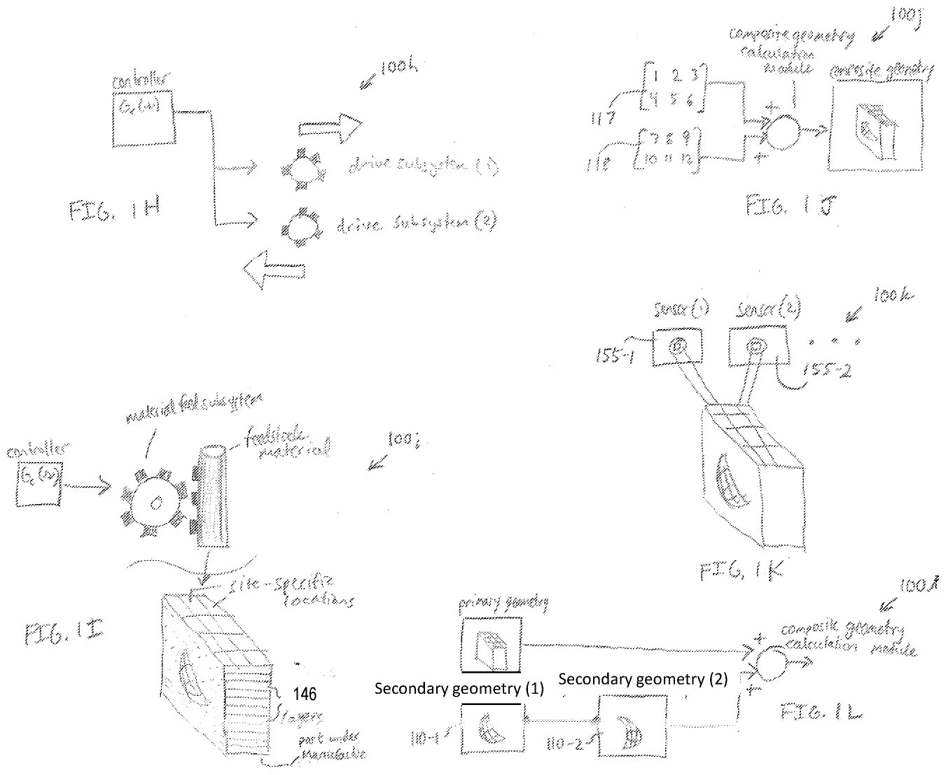

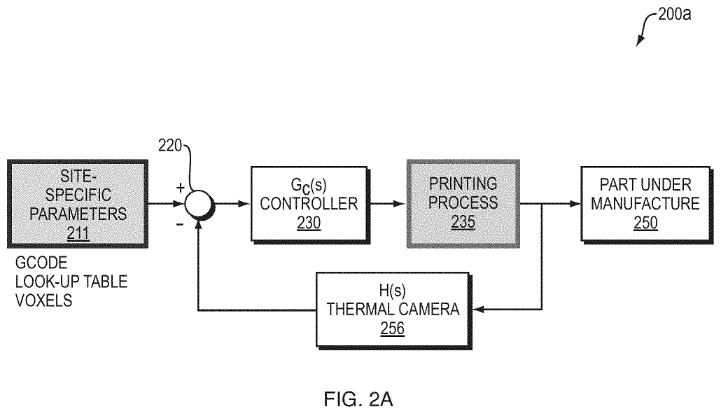

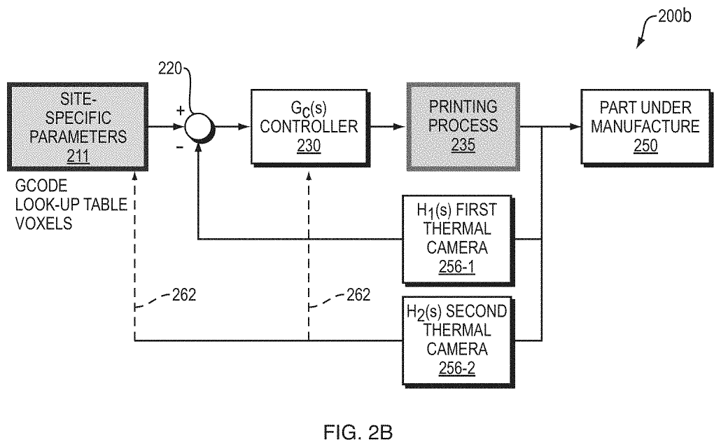

FIG. 2A is a schematic block diagram of a system 200a for additive manufacturing using site-specific closed-loop feedback control. The system 200a may be configured to accept site-specific parameters 211 as inputs. The site-specific parameters 211 may include, for example, G-code, a lookup table, voxel representations, or other possible means of providing geometry information to the system 200a. The site-specific parameters 211 may be generated by the system 200a or a processor thereof based on the composite geometry 115, or based on at least one of the primary geometry 105 and the secondary geometry 110. The system 200a may include a controller 230 configured to control a printing process 235 in order to produce a part under manufacture 250. In some embodiments, a sensor such as a thermal camera 256 may be configured to sense aspects of the printing process 235 or the part under manufacture 250, producing a signal to be compared with the site-specific parameters 211 by a comparison unit 220 in order to produce a signal to stimulate the controller 230 to control the printing process 235 according to the actuating error signal. The calculated signal to stimulate the controller may be the actuating error signal 125 as previously described.

Embodiments of the system 200a as depicted in FIG. 2A may be configured to attach site-specific controller set-points to a toolpath in additive manufacturing. The thermal camera 256 or other sensors may be configured to provide dynamic bead geometry control during the printing process 235. The system 200a may thus be configured to implement adjustments to thermal properties of the part under manufacture 250. The system 200a is thus able to exhibit increased process resolution such as, for example, a capability to emboss a feature of the secondary geometry 110 on the primary geometry 105 of a part 250. The system 200a, by incorporating site-specific parameters 211 with signals from sensors such as the thermal camera 256, enables defect mitigation techniques to be implemented during the printing process 235.

In some embodiments, a melt pool size signal may be provided to a closed-loop controller that manipulates a laser power parameter in real-time to control a melt pool size. The controller may be of a typical linear, feedback control architecture, or other more advanced feedback control architectures that are novel or already known in the art. The controller may be tuned for set-point tracking, disturbance rejection, or a combination of multiple performance objectives.

FIG. 2B is a schematic block diagram of a system 200b for additive manufacturing using a site-specific closed-loop control architecture including both feedback and feed-forward components. In some embodiments of the system 200b, at least two sensors such as thermal cameras 256-1, 256-2 are included. The thermal cameras 256-1, 256-2 may be mutually or separately configured to sense aspects of the part under manufacture 250 at respective site-specific locations 145, or to sense respective features at the same location of a part under manufacture 250. Such respective site-specific locations 145, or features, may be at a proximal location to the site-specific location of the melt pool 140 or at a distal location from the site-specific location of the melt pool 140, or a combination thereof. For example, a system 200b may be configured to adjust a setpoint for a present layer of a part under manufacture 250 based on a temperature sensed at a given completed layer of the part under manufacture 250. Such an adjustment may include changes to a gain setting of the controller 230.

In some embodiments of the system 200b, as depicted in FIG. 2B, a first thermal camera 256-1 is configured to sense aspects of the printing process 235 or the part under manufacture 250, producing a signal to be compared with the site-specific parameters 211 by a comparison unit 220 in order to produce a signal to stimulate the controller 230 to control the printing process 235 according to the actuating error signal. A second thermal camera 256-2 may be configured to sense aspects of the printing process 235 or the part under manufacture 250, producing a signal to adjust a setpoint directly via either the site-specific input parameters 211 or the controller 230.

In some embodiments of the system 200b of FIG. 2B, setpoints may be adjusted via the site-specific input parameters 211 or the controller 230 to control at least one of a power control parameter, translation rate parameter, or feedstock rate parameter of the printing process 235. The second thermal camera 256-2 of FIG. 2B thus provides for dynamic control of parameters of the printing process 235. Parameters of the printing process 235 may thus be controlled as a function of the data provided by the aforementioned sensors, such as the temperature data sensed by the second thermal camera 256-2.

Alternatively to employing multiple thermal cameras 256-1, 256-2, a wide-angle thermal camera may be used to sense multiple features across a region such as an entire layer of a part under manufacture 250, or part of a layer.

It should be understood that in other embodiments of a system 200b, the first thermal camera 256-1 may be configured to produce a signal to adjust setpoints as described hereinabove with respect to the second thermal cameral 256-1. It should also be understood that in some embodiments, more than two thermal cameras may be employed in such a fashion. It should also be understood that other sensor types may be used in lieu of the exemplary thermal cameras described hereinabove.

In some embodiments, the desired melt pool size set-point may be provided to the controller in pixels. This parameter may be changed at specified trigger points. Locations of the trigger points may be determined by interactions, such as intersections, between primary and secondary geometries. Secondary geometries may herein be referred to interchangeably as “second” geometries. In addition to laser power being continuously modulated, other process variables may also be subjected to manipulation through additional process control methods. A laser line scanner on the print head may be used to measure layer height, relative to a nominal ideal 200 layer height, on an interlayer basis. Deviations in layer height may drive parameter modifications on subsequent layers to correct errors, a process described in reference [11]. Table 1 displays examples of nominal deposition values used for an example geometry of some embodiments according to the present disclosure.

TABLE 1
Primary Process Parameters.

| Parameter | Value | Units |
|---|---|---|
| Delivered Laser Power | 8.71 | kW |
| Deposition Rate | 2.4 | kg/hr |
| Print Speed | 8 | mm/s |
| Layer Height | 1.6 | mm |
| Bead Stepover | 9.5 | mm |

Some embodiments may use, as feedstock, Ti-6Al-4V wire with, for example, a 1.6 mm diameter. A build plate material may also be Ti-6Al-4V, with, for example, a 6.35 mm (0.25 inch) thickness. Deposition rate may be a function of a feedstock rate parameter, wire diameter, and feedstock density (4.43 g/cm3 for Ti-6Al-4V). A delivered amount of laser power may be determined through a calibration process using a power measurement device. In some embodiments, depositions may be completed in, for example, an Argon environment maintained by a tent-like enclosure that surrounds the build plate. The enclosure may be purged prior to commencement of manufacturing. In some embodiments, a steady flow of Argon throughout the printing process may maintain Oxygen levels below, for example, 300 ppm.

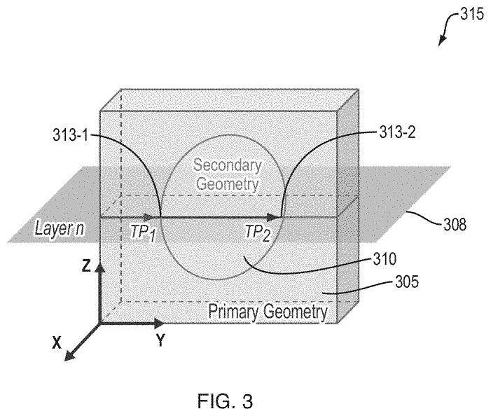

FIG. 3 is a graphical representation of example primary 305 and secondary 310 geometries plotted together on a common print head coordinate system, with trigger points 313-1, 313-2 shown. The primary geometry 305 is the traditional geometry that would be input to a slicer, i.e., it is the basic 3D part or object to be manufactured or printed. The object is sliced into layers 308 that are oriented with the X-Y plane, which are then filled with pathing. Layers 308 of the primary geometry correspond to layers 146 of the part under manufacture. The secondary geometry 310 in the depicted example is a 2D geometry oriented with the Y-Z plane. This is not the only representation or orientation that is possible, however. Other formats may make sense for accomplishing different objectives. The intersections between the layer 308 and the secondary geometry 310 drive the generation of trigger points 313-1, 313-2, which may be defined as distances from a common edge such as a leading edge of the primary geometry 305, which for the depicted example is the starting point for the pathing for each layer 308. The trigger points 313-1, 313-2, may be stored in memory in a format that can be attached to the tool path and used by an additive manufacturing system. For the example depicted in FIG. 3, the trigger points 313-1, 313-2, may be understood to be used by the additive manufacturing system to command step changes in melt pool size. Therefore, two trigger points 313-1, 313-2, form a complete step in melt pool size (with melt pool size increasing by a prescribed magnitude, and then decreasing back to nominal size).

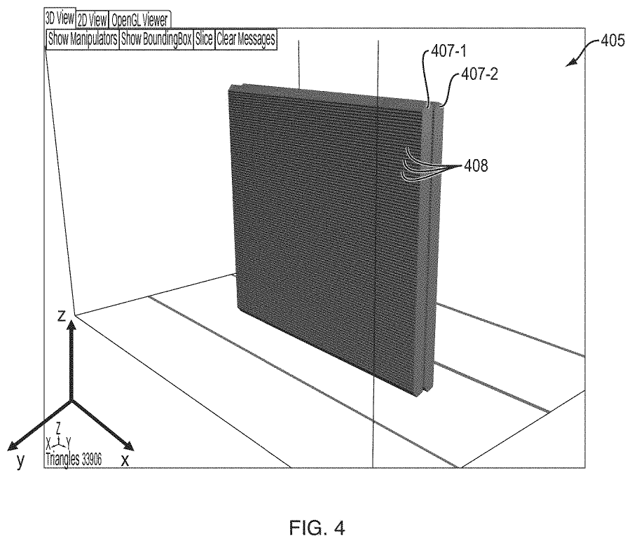

FIG. 4 depicts a simulated view of a primary geometry 405, according to an embodiment. The primary geometry 405 for this embodiment is a double-bead wall 407-1, 407-2, 175 mm in length and 150 mm in height (94 layers with a 1.6 mm layer height) with two paths per layer 408, known as skeletons. In the embodiment, the primary geometry 405 is implemented in a specially-developed large-scale AM computerized slicer environment. Beads may be deposited with, for example, a front-feed wire orientation, or with any other wire feed orientation. An exception to the front-feed wire orientation may be a configuration initiated by a bead termination routine that takes place at the end of a bead, in which the print head reverses to deposit additional material for a prescribed distance. The prescribed distance may evolve on a per-layer basis. This routine may serve as an additional measure to maintain proper layer height. The reversal distance and the nominal deposition rate may evolve throughout the termination routine. In addition to helping maintain layer height, the use of the termination routine can also manifest as slight variations in lateral width of one layer with respect to a previous layer.

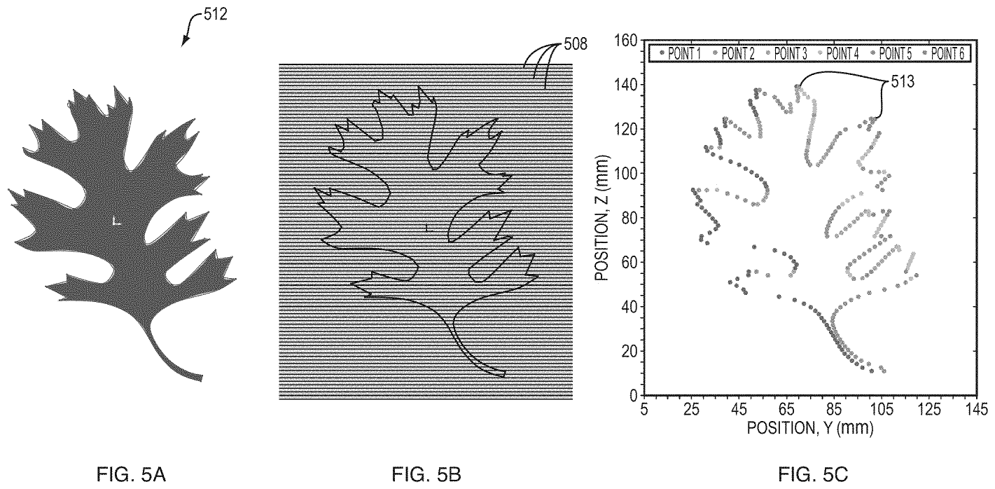

FIGS. 5A-C depict an example embodiment in which an oak leaf was selected as a secondary geometry 310. The oak leaf is a complex geometry that affords an opportunity to study melt pool size response over a large variety of step durations, as a function of step distance and print speed. The depicted example oak leaf design, segmented with layers, contains 139 total steps, 116 of which are of unique distances, ranging from 0.7 mm to 77.5 mm. An example conceptual workflow for the generation of trigger points 513 for the oak leaf design can be seen in FIGS. 5A-C.

FIG. 5A shows a 2D sketch 512 of the geometry. The workflow begins with such a sketch 512.

FIG. 5B shows the sketch 512 being scaled and segmented into layers 508 using the known layer height.

FIG. 5C shows that the intersection points of the secondary geometry 310 and the layer lines 508 become the trigger points 513 at which the melt pool size set-point will change. For this embodiment, trigger points 513 are limited to six per layer 508, yielding a maximum of three complete step changes in melt pool size per layer 508. This requires some filtering of fine details from the oak leaf geometry, particularly at the leaf tips, but maintains the overall design and sufficient complexity. The trigger points 513 are color coded in FIG. 5C to show the progression and number of trigger points 513 on a per-layer basis.

In the example embodiment, the first wall 407-1 contains step changes in only the second of two beads per layer, and the step changes command the melt pool size 25% higher than nominal. The second wall 407-2 contains step changes in both beads, and the melt pool size is commanded 37.5% higher than nominal. This embodiment provides an experimental setup, which allows for a comparison of melt pool size and laser power response across beads and across magnitudes of step changes. This is summarized in Table 2. The nominal melt pool size may be determined through testing, in which deposits may be made with nominal parameters while only monitoring with a thermal camera; the measured melt pool size then subsequently becomes the set-point for control. The increased melt pool size may be selected to produce a large increase in size while still maintaining process stability.

TABLE 2
Example Size Parameters of a Melt Pool for a Test Wall.

| | | |
|---|---|---|
| Test | Nominal Melt Pool Size | Increased Melt Pool Size |
| Wall | (pixels) | (pixels) |

Wall 1

| | | |
|---|---|---|
| Bead 1 | 2450 | N/A |
| Bead 2 | 2450 | 3063 |

Wall 2

| | | |
|---|---|---|
| Bead 1 | 2450 | 3369 |
| Bead 2 | 2450 | 3369 |

The stability concern arises from the fact that if laser power increases too much, the wire feedstock can begin to transfer in droplet form, at which point it is difficult, if not impossible, to measure the melt pool size. Additionally, a command for a larger melt pool size may result in an increase in laser power, which, without a corresponding increase in wirefeed rate, results in a wider and shorter bead profile. In theory, if this behavior happened repeatedly on a layer by layer basis, a height deficit could propagate and result in a major defect. The previously discussed layer height control method counteracts this effect through interlayer scanning and modification of the parameters of the following layer. While the melt pool size controller and the layer height controller operate concurrently, the systems may have no a priori knowledge of the other's actions, meaning that interesting interactions between the systems are certainly possible.

A response of the melt pool size control system may be characterized by examining the melt pool size and laser power behavior at the selected locations. The scaled melt pool size data may be overlaid with robot position feedback data to generate a visualization of melt pool size for an entire half of a wall. The robot may be referred to interchangeably herein as the “drive subsystem.” In the example embodiment, the melt pool response time may be specifically examined in the region of the oak leaf stem in wall 2 407-2, which contained step changes of a larger magnitude than those of wall 1 407-1. The stem may contain a range of steps that are relatively short in duration, an ideal scenario for evaluating a minimum duration for which the melt pool set-point could actually be achieved, i.e., the process resolution.

Final part geometry may be characterized via scanning with, for example, a FaroArm scanner, which generates virtual, 3D representations of the printed components. This allows for a comparison of the geometry of the printed or manufactured part against an ideal representation of a flat wall with no embossed, secondary geometry. Magnitudes of oak leaf embossing can be determined and compared across test cases.

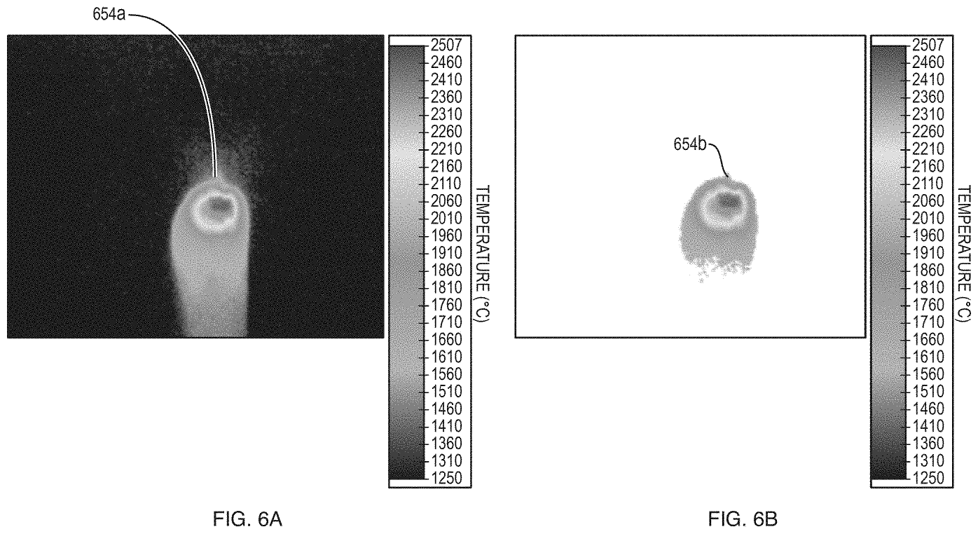

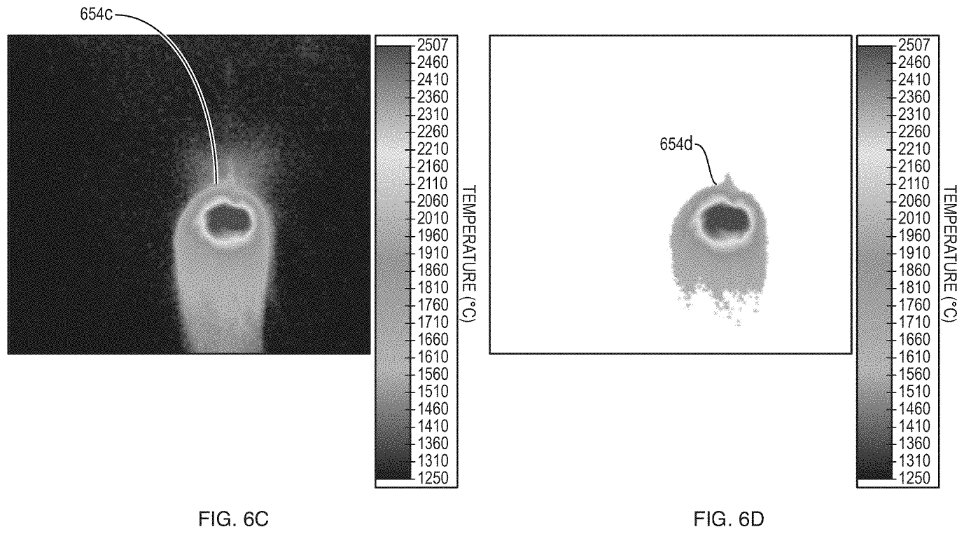

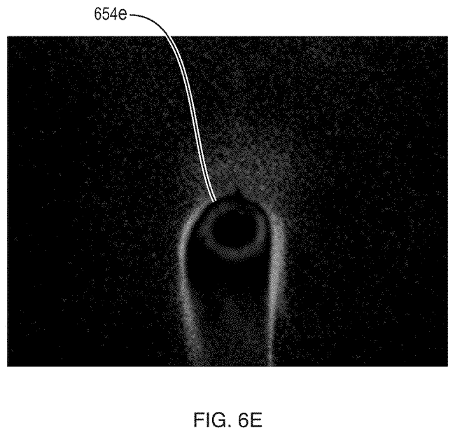

FIGS. 6A-E depict example false-color images from a thermal camera of the example embodiment of FIGS. 5A-C, along with corresponding thresholded images that contain only that which is defined as the melt pool.

FIG. 6A shows an as-collected representation of the melt pool of the example embodiment in a nominally-sized state 654a, imaged using a thermal camera of the embodiment.

FIG. 6B shows a thresholded version of the image of the nominally-sized melt pool 654b of FIG. 6A.

FIG. 6C shows an as-collected representation of the melt pool after the melt pool has been enlarged 654c.

FIG. 6D shows a thresholded version of the image of the enlarged melt pool 654d of FIG. 6C.

FIG. 6E shows an as-collected comparison 654e of the image of the nominally-sized melt pool of FIG. 6A with the image of the enlarged melt pool of FIG. 6C. The comparison of FIG. 6E is shown via a subtraction of RGB values in which the melt pool size difference between the high and low cases manifests as a bright green region against a field of black.

In the example embodiment of FIGS. 5A-C, during wall printing, laser power is modulated as expected according to the trigger points 513, and a desired melt pool size can thus be achieved at the trigger points 513. Qualitative evidence of this is available in FIGS. 6A-E, which show thermal camera images of the melt pool from bead 1 of layer 35 in wall 2.

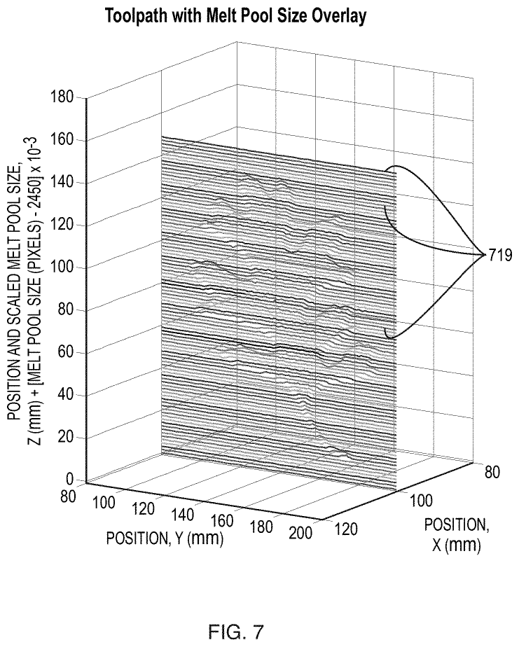

FIG. 7 depicts, for the example embodiment of FIGS. 5A-C, an overlay of the melt pool size data from an entire half of a wall with a corresponding toolpath, i.e., feedback position data from the print head. The overlay provides a high-level confirmation that desired site-specific changes in melt pool size were achieved as specified by the secondary geometry 310. Bead 1 of wall 2 was selected for this visualization. The melt pool size may be scaled such that changes in magnitude would nicely show the secondary geometry 310. This may be accomplished by subtracting the nominal melt pool size (e.g., 2450 pixels) and scaling by a factor of 10⁻³; the scaled value may then be added to a print head Z-height position on a point-by-point basis. The oak leaf is clearly visible in the overlaid melt pool size data 719 in FIG. 7.

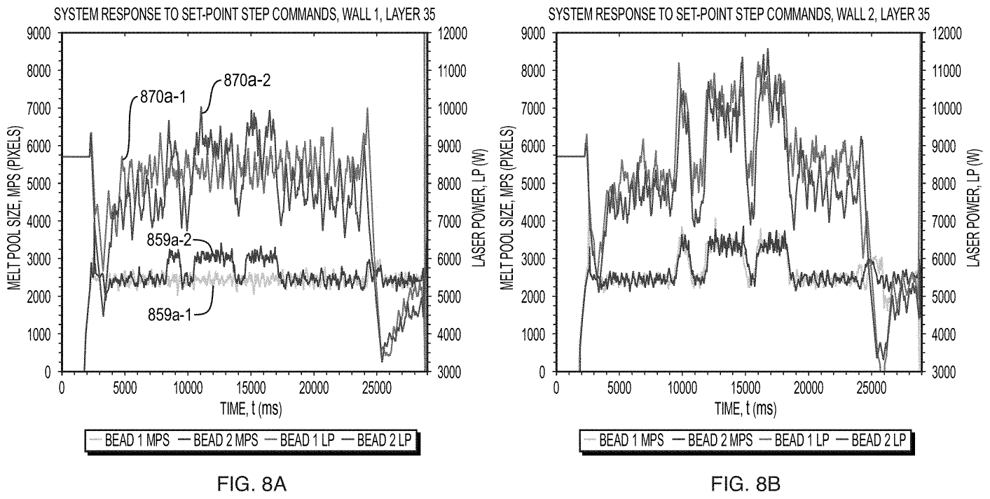

FIGS. 8A-B respectively display, for the example embodiment of FIGS. 5A-C, laser power data and melt pool size response data for both beads of layer 35 for each wall 407-1, 407-2, providing a more detailed look at laser power modulation. Layer 35 was selected because it contains the maximum of three step changes, and each step change is sufficiently long to allow the system to achieve the desired melt pool size at set-points. In wall 1, bead 1 did not contain any site-specific step changes in melt pool size 859a-1, or in laser power 870a-1. The melt pool can thus be seen in FIG. 8A to be controlled at the nominal size (e.g., 2450 pixels) throughout the bead. Some increased error is evident as the print head enters the bead termination routine (at −24 seconds on FIGS. 8A-B), at which point laser power is significantly modulated to control melt pool size in a highly transient thermal condition that tests disturbance rejection capabilities of the controller, rather than set-point tracking performance. In bead 2, three step changes in melt pool size 859a-2 are present, and laser power 870a-2 is modulated over a range of approximately 1.5-2 kW to achieve a higher melt pool size (e.g., 3063 pixels). It is noteworthy that the laser power required to achieve the nominal melt pool size may be lower for bead 2, compared to bead 1, by approximately 0.5-1 kW. This result is not unexpected, in that residual heat present in the wall after the deposition of bead 1 contributes to the deposition of bead 2, in what can be thought of as a secondary heating or insulating effect; the inter-bead time, or the duration from laser-off of bead 1 to laser-on of bead 2, is only 16 seconds in the example embodiment of FIGS. 5A-C. After the deposition of bead 2, however, there may be a longer cooling time before the deposition of bead 1 of the subsequent layer; the interlayer time, which includes the built height scan, is 89 seconds in the example embodiment.

In the example embodiment of FIGS. 5A-C, in wall 2, both beads can be seen in FIG. 8B to contain site-specific step changes in melt pool size 859b-1, 859b-2. The secondary geometry 310 is shifted +10 mm in the Y-axis for wall 2 to better position the oak leaf within the wall; this is evident as a slight shift in time of the step changes for wall 2 compared to wall 1. The laser power magnitude required to achieve the nominal melt pool size in wall 2 is remarkably similar to that of wall 1, and again, bead 2 laser power 870b-2 trends lower than bead 1 laser power 870b-1. Where differences arise are in the step changes. Larger modulations in laser power, on the order of 2-3 kW, help to achieve the increased melt pool size. Interestingly, the largest and most distinct difference between bead 1 laser power 870b-1 and bead 2 laser power 870b-2 occurs at two inter-step returns to nominal melt pool size, at which point bead 2 laser power 870b-2 is approximately 1 kW lower than that 870b-1 of bead 1. Residual heat may thus contribute to a need for larger reductions in laser power in order to return the melt pool to the nominal size.

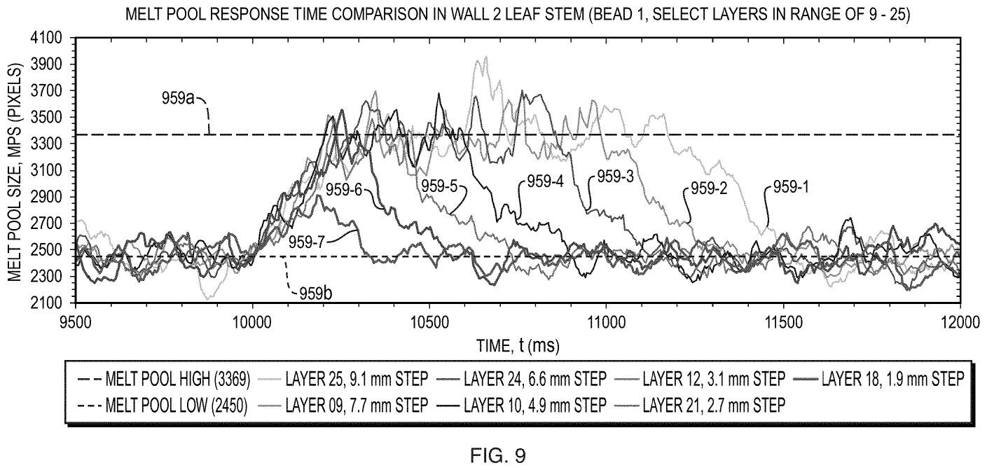

FIG. 9 depicts an examination of melt pool size step response for select layers in the stem region of the oak leaf of the example embodiment of FIGS. 5A-C. The stem region contains a range of steps that are relatively short in duration. Wall 2 was selected for this analysis, due to its larger magnitude step changes. Specifically, layers 9-25, which contained single step changes in the oak leaf stem, were examined. Curves were temporally aligned using the rising edge of the melt pool size signal to allow for direct comparisons among step durations. A threshold is established to define a set-point for an enlarged melt pool 959a and is depicted in FIG. 9 with a dotted line. An additional dotted line shows the nominal melt pool size 959b. It can be seen in FIG. 9 that 2.7 mm, the step distance of layer 21 959-6, is the minimum step distance for which the higher melt pool size set-point 959a (e.g., 3369 pixels) could be achieved in the example embodiment of FIGS. 5A-C. For the combination of primary process parameters used to print the walls of the example embodiment of FIGS. 5A-C, 2.7 mm would thus be considered the extra-toolpath feature resolution for which full embossing could be achieved. The 2.7 mm step distance, in combination with an 8 mm/s print speed and a 919 pixel step magnitude, corresponds to a 37 msec per 100 pixel rise time, which is remarkably similar to that which has been documented in prior work on this laser-wire DED process [2]. Step distances shorter than this are characterized by melt pool size responses that did not attain the higher set-point 959a; one such example is shown in FIG. 9 for layer 18 959-7. In all, in the example embodiment, there are 18 steps shorter than 2.7 mm in the oak leaf design, with 7 of those located in the stem region of the oak leaf. Step distances longer than thee extra-toolpath feature resolution are shown in FIG. 9 for layer 25 959-1, layer 09 959-2, layer 24 959-3, layer 10 959-4, and layer 12 959-5.

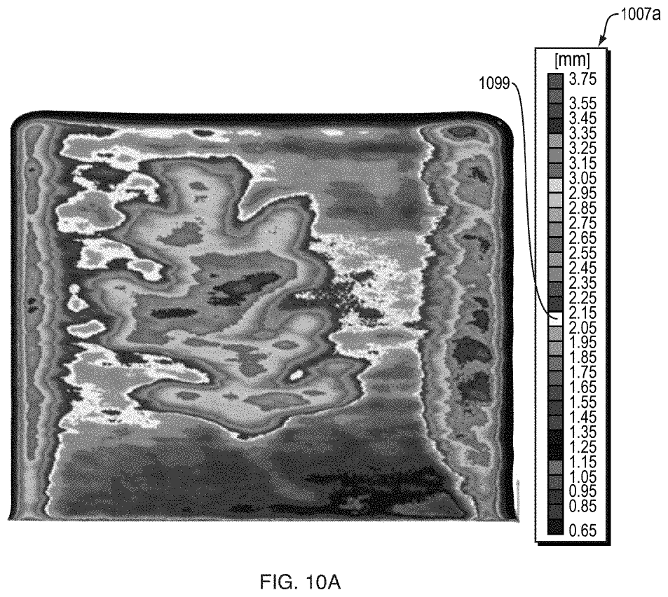

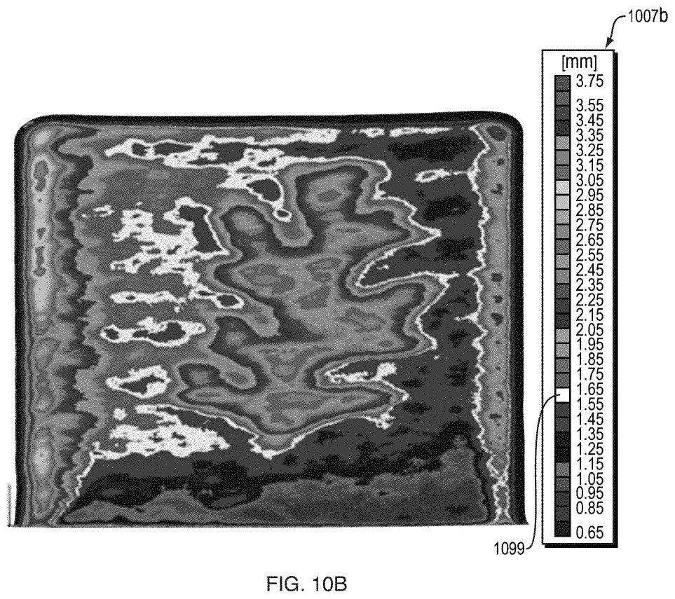

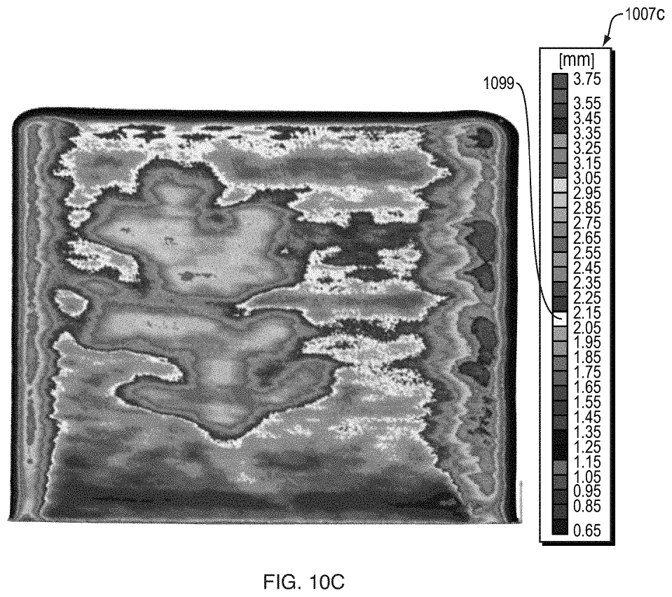

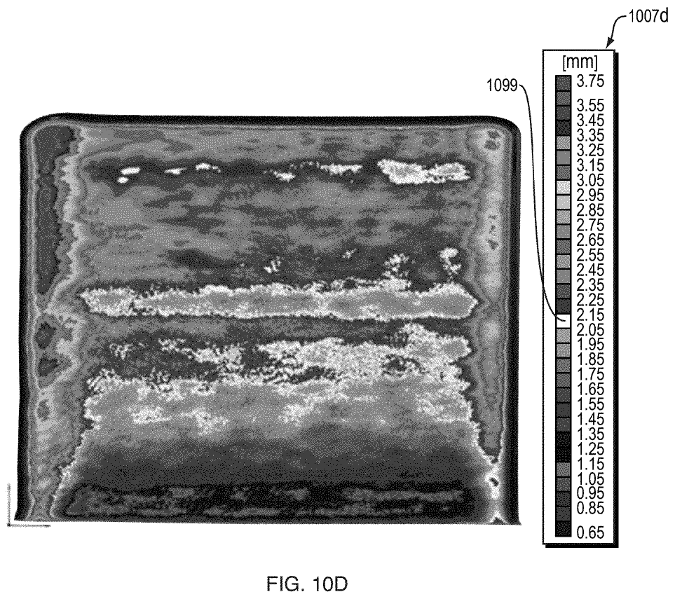

FIGS. 10A-D depict thickness color maps resulting from scans of the wall geometries produced according to the example embodiment of FIGS. 5A-C. The thickness color maps reveal the embossed, or extra-toolpath, geometry achieved through site-specific melt pool size control. Thickness color maps such as those of FIGS. 10A-D may be generated by comparing a scanned, as-printed geometry with that of a flat reference wall, like that used for slicing purposes; the thickness magnitude represented by the color scale is the difference between the two geometries. Relative positioning of the reference wall and the scanned geometry in the inspection software may lead to some differences in the color scale from case to case. Because of this, a white reference marker 1099 may be inserted into the color scale at a position believed to represent the average steady-state wall surface outside of the oak leaf, as seen in FIGS. 10A-D. Embossing measurements can then be made in comparison to the thickness magnitude of this white reference marker 1099 on a case-by-case basis. Thickness color maps are shown for both sides of both Walls 1 and 2 in FIGS. 10A-D.

FIG. 10A shows a thickness color map 1007a for wall 2, side 2 of the part under manufacture of the example embodiment of FIGS. 5A-C. The maximum embossing of the oak leaf achieved on wall 2, side 2 was 1.5 mm. The maximum of 1.5 mm corresponds to 7.2% of the total wall thickness of 20.7 mm.

FIG. 10B shows a thickness color map 1007b for wall 2, side 1 of the part under manufacture of the example embodiment of FIGS. 5A-C. The maximum embossing of the oak leaf achieved on wall 2, side 1 was 1.2 mm.

FIG. 10C shows a thickness color map 1007c for wall 1, side 2 of the part under manufacture of the example embodiment of FIGS. 5A-C. The maximum embossing of the oak leaf achieved on wall 1, side 2 was 1 mm.

FIG. 10D shows a thickness color map 1007d for wall 1, side 1 of the part under manufacture of the example embodiment of FIGS. 5A-C. This wall and side are not subject to any site-specific changes to the melt pool size set-point in the example embodiment of FIGS. 5A-C; instead, they provide a nominal reference in which some thickness variation is evident from the bottom to the top of the wall. Increases in thickness at the bead initiation and termination regions are evident and were expected.

It can be determined from FIGS. 10A-B that, for the example embodiment of FIGS. 5A-C, the total through-thickness from a combination of sides 1 and 2 of wall 2 was 2.7 mm, or 13% of total wall thickness. The respective oak leaves of sides 1 and 2 of wall 2 are mirror images of each other. The oak leaf stem region is more readily discernable on wall 2 in FIG. 10A, although its prominence is still reduced due to the previously discussed melt pool size response time and resolution limitations.

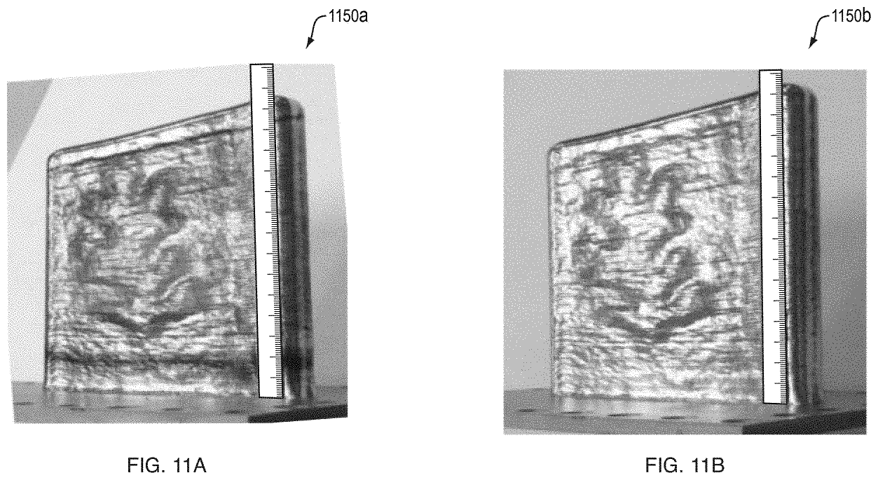

FIGS. 11A-B depict photographs of side 2 of wall 2 of the part under manufacture of the example embodiment of FIGS. 5A-C. The extra-toolpath geometry is clearly visible on the side of the wall.

FIG. 11A shows a photograph 1150a of side 2 of wall 2 of the part under manufacture of the example embodiment of FIGS. 5A-C, subsequent to deposition, but before a post-print heating of the part for stress relief.

FIG. 11B shows a photograph 1150b of side 2 of wall 2 of the part under manufacture of the example embodiment of FIGS. 5A-C, after both walls were subjected to a post-print stress-relief heat treatment (e.g., 720° C. for t>2 hours or 650° C. for t>2.5 hours for Ti-6Al-4V). The heat treatment process removes surface oxides (coloration) from the walls (visible in FIG. 11A), giving the part a uniform appearance.

In some embodiments, a combination of site-specific parameters 211 with closed-looped feedback control enabled by a sensor 155 provide dynamic bead geometry control in a printing process 235 of an additive manufacturing system 100a, 200a, 200b. In some embodiments, such dynamic bead geometry may enable use of varied controller set points on a location specific basis. In some embodiments, such dynamic bead geometry control may be provided on an intra-layer or an inter-layer basis. Application of inter-layer control in an additive manufacturing process, in conjunction with site-specific parameters derived from a combination of multiple model geometries, has heretofore not been considered an economical use of manufacturing resources, until development of the methods and systems of the present disclosure.

In some embodiments, dynamic bead geometry control, provided as described hereinabove, may enable the use of extra toolpath geometry beyond the toolpath of a primary geometry 105. In some embodiments, such dynamic bead geometry control may enable, for example, implementation of an embossing effect on a part under manufacture 150. In some embodiments, such dynamic bead geometry control may be used for printing embossed characters, QR codes, or other features on a surface of a part under manufacture 150. In some embodiments, such embossed features may be used to support various security considerations for a part under manufacture 150. In some embodiments, such embossed features may be targeted features used for addressing and eliminating volumetric defects for a part under manufacture 150.

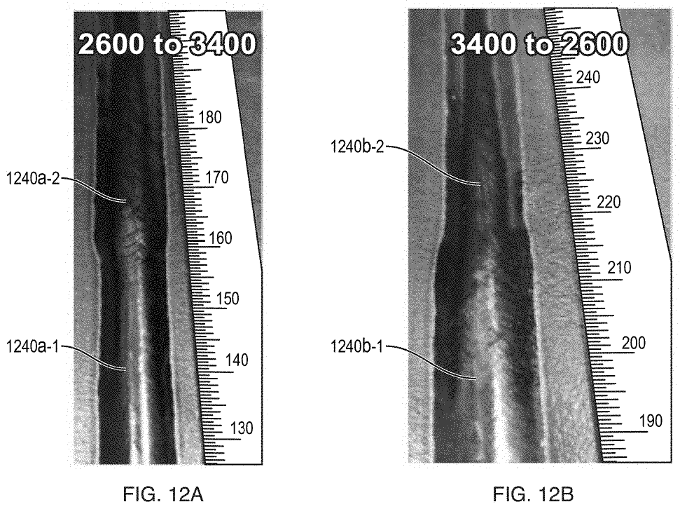

FIGS. 12A-B are photographs of beads produced by a print head 190 of a system for additive manufacturing 100a, 200a, 200b. In an embodiment, through a combination of site-specific parameters 211 and a feedback signal 160 from a sensor 155, a melt pool 140 may be controlled to change in size during manufacturing of the bead on a given layer of the part under manufacture 150. The travel direction of the print head 190 is from the bottom to the top of the respective photographs.

FIG. 12A shows a transition from a melt pool diameter of 2600 pixels to 3400 pixels. In the photograph, a first section 1240a-1 of the bead having the narrower, 2600 pixel melt pool diameter and a second section 1240a-2 of the bead, having a melt pool diameter of 3400 pixels can be seen distinctly from each other with a transition region in between.

FIG. 12B shows a transition from a melt pool diameter of 3400 pixels to 2600 pixels. In the photograph, a first section 1240b-1 of the bead having the wider, 3400 pixel melt pool diameter and a second section 1240-b2 of the bead, having a melt pool diameter of 2600 pixels, can be seen distinctly from each other with a transition region in between.

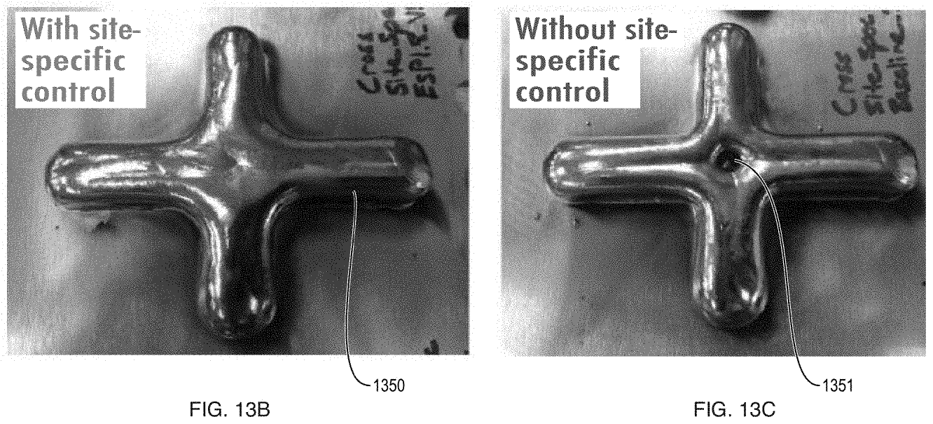

FIG. 13A is a two-dimensional plot showing a representation of a toolpath 1317 for a layer 146 for a part under manufacture 150, according to an embodiment. The plot of FIG. 13A also shows a two-dimensional secondary geometry 110 in the form of a bounding box 1318. Such a bounding box 1318 may be used, for example, for purposes of defect mitigation. For example, a toolpath in the shape of a cross may boast broad utility in many additive manufacturing applications, but such a toolpath is often problematic in that it often produces a large void near the center of the part under manufacture 150. By using the bounding box 1318, the additive manufacturing system may be programed to adjust various parameters of the plant 135 of the system to minimize the void affecting the center of the part under manufacture 150. For example, inside the bounding box, melt pool size set-point may increase by 80% while print speed may decrease by 37.5%. Inside the bounding box, laser power may be modulated automatically, based on the actuating error signal 125, changing the melt pool size and thus minimizing the effect of the void that develops at the center of such a cross-shaped toolpath.

FIG. 13B is a photograph of a part 1350 produced by a cross-shaped toolpath, according to an embodiment. In the part 1350 of FIG. 13B, site-specific control was used according to the bounding box method described above, to minimize the voiding effect at the center of the part 1350.

FIG. 13C is a photograph of part 1351 produced using a cross-shaped toolpath without any form of site-specific control, according to an embodiment. In the part 1351 of FIG. 13C, a void of much greater diameter and depth is visible at the center of the part 1351. The void of part 1351 is clearly of much greater size, in three dimensions, than a slight depression visible at the center of part 1350 of FIG. 13B. It is thus apparent that, in some embodiments, site-specific closed-loop control may be used for mitigation of defects such as a voiding effect commonly observed with parts produced using cross-shaped toolpaths.

In some embodiments, closed-loop, site-specific control of melt pool size is utilized to impart local process changes and print an extra-toolpath geometry, i.e., a geometry that occurs beyond the toolpath. Such control may be applied to many other embodiments, which may differ from the example embodiment at least in the nature of the part under manufacture, or in the configuration of the additive manufacturing system. An embossing resolution of an extra-toolpath geometry may be dependent upon the melt pool size response time and the print speed. The ability of this technique to control local bead geometry has interesting implications, particularly for a large-scale additive manufacturing process like laser-wire DED, which requires a different set of design rules than a majority of additive manufacturing processes, and has traditionally been limited to lower resolution of component details [13]. This technique may be used for volumetric defect mitigation in toolpaths where local overlap of adjacent beads is inadequate. The capability to emboss specific, secondary geometry means that part identification features, such as a serial number or QR code, can be permanently added to components during the printing process. The capability to print single toolpath walls with varying wall widths is also attractive from a post-print machining perspective, in that, when machining thin-walled structures, pre-forms ideally contain integrated structural support such as thicker sections that buttress and support adjacent thinner sections during the machining process.

An important aspect of the techniques demonstrated herein is the closed-loop nature of the process. While it would certainly be possible to pre-program open-loop, site-specific modifications to process parameters in laser-wire DED, a closed-loop system ensures that variables, like melt pool size, are controlled regardless of thermal properties of the part under manufacture. This is evident in the laser power magnitude variance between beads 1 and 2 of the walls in the example embodiment described hereinabove. A model-referenced feed-forward approach may provide an improvement over feed-forward alone, but there are certain things that are difficult to model, like unexpected print interruptions, which can happen at any time and have varying durations.

Another embodiment of a method that may be used to emboss secondary geometry is to actually make the secondary geometry 310 part of the primary toolpath, in that the sliced 3D object would contain the geometry to be embossed, and the toolpath would joggle laterally while nominal process parameters are maintained to create the embossing. An issue associated with this method is that toolpath turns generally induce print head velocity reductions, which can be a challenge to handle from a process stability perspective, particularly when they are sharp turns, like those likely associated with secondary geometry embossing. Additionally, the small, localized nature of the toolpath joggles may induce print system vibrations that are undesirable.

In some embodiments, impacts of site-specific melt pool size control on cooling rates, solidification dynamics, and thermal cycling, drive the resulting microstructure and mechanical properties in metal additive manufacturing, and facilitate local property control with an eye toward functionally grading components in accordance with the demands of their applications [17-19].

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

### REFERENCES

1. Babu, S. S.; Love, L.; Dehoff, R.; Peter, W.; Watkins, T. R.; Pannala, S. Additive manufacturing of materials: Opportunities and challenges. MRS Bulletin 2015, 40, 1154-1161, doi:10.1557/mrs.2015.234.
2. Gibson, B.; Bandari, Y. K.; Richardson, B.; Henry, W. C.; Vetland, E. J.; Sundermann, T. W.; Love, L. Melt pool size control through multiple closed-loop modalities in laser-wire directed energy deposition of Ti-6Al-4V. Report, Oak Ridge National Lab: 2019.
3. Hofmeister, W.; Knorovsky, G. A.; Maccallum, D. O. Video Monitoring and Control of the LENS Process. In Proceedings of the American Welding Society 9th International Conference of Computer Technology in Welding, Detroit, Mich., USA, Sep. 28-30, 1999.
4. Hu, D.; Kovacevic, R. Modelling and measuring the thermal behaviour of the molten pool in closed-loop controlled laser-based additive manufacturing. Proceedings of the Institution of Mechanical Engineers, Part B: Journal of Engineering Manufacture 2003, 217, 441-452, doi:10.1243/095440503321628125.
5. Hu, D.; Mei, H.; Tao, G.; Kovacevic, R. Closed-loop control of 3D laser cladding based on infrared sensing. Solid Freeform Fabrication Symposium 2001.
6. Zalameda, J. N.; Burke, E. R.; Hafley, R. A.; Taminger, K. M.; Domack, C. S.; Brewer, A.; Martin, R. E. Thermal imaging for assessment of electron-beam freeform fabrication (EBF3) additive manufacturing deposits. In Proceedings of Proc. SPIE.
7. Gibson, I.; Rosen, D.; Stucker, B. Additive manufacturing technologies: 3D printing, rapid prototyping, and direct digital manufacturing. 2015.
8. Lee, Y. S.; Kirka, M. M.; Dinwiddie, R. B.; Raghavan, N.; Turner, J.; Dehoff, R. R.; Babu, S. S. Role of scan strategies on thermal gradient and solidification rate in electron beam powder bed fusion. Additive Manufacturing 2018, 22, 516-527, doi: 10.1016/j.addma.2018.04.038.
9. Dehoff, R. R.; Kirka, M. M.; Sames, W. J.; Bilheux, H.; Tremsin, A. S.; Lowe, L. E.; Babu, S. S. Site specific control of crystallographic grain orientation through electron beam additive manufacturing. Materials Science and Technology 2015, 31, 931-938, doi:10.1179/1743284714Y.0000000734.
10. Gibson, B.; Bandari, Y. K.; Richardson, B.; Roschli, A.; Post, B.; Borish, M.; Thornton, A. S.; Henry, W. C.; Lamsey, M. D.; Love, L. Melt pool monitoring for control and data analytics in large-scale metal additive manufacturing. In Proceedings of International Solid Freeform Fabrication Symposium, Austin, Tex., USA, Aug. 12-14, 2019.
11. Borish, M.; Post, B. K.; Roschli, A.; Chesser, P. C.; Love, L. J.; Gaul, K. T. Defect Identification and Mitigation Via Visual Inspection in Large-Scale Additive Manufacturing. JOM 2019, 71, 893-899, doi:10.1007/s11837-018-3220-6.
12. Bristow, D. Melt pool measures and effective sensor bandwidth for direct energy deposition. In Proceedings of International Solid Freeform Fabrication Symposium, Austin, Tex., USA, Aug. 12-14, 2019.
13. Greer, C.; Nycz, A.; Noakes, M.; Richardson, B.; Post, B.; Kurfess, T.; Love, L. Introduction to the design rules for Metal Big Area Additive Manufacturing. Additive Manufacturing 2019, 27, 159-166, doi: 10.1016/j.addma.2019.02.016.
14. Aremu, A. O.; Brennan-Craddock, J. P. J.; Panesar, A.; Ashcroft, I. A.; Hague, R. J. M.; Wildman, R. D.; Ruck, C.; A Voxel-Based Method of Constructing and Skinning Conformal and Functionally Graded Lattice Structures Suitable for Additive Manufacturing. Aditive Manufacturing 2017, 13, 1-13, doi: 10.1016/j.addma.2016.10.006.
15. Wittkopf, J.; Erickson, K.; Olumbummo, P.; Hartman, A.; Howrd, T.; Zhao, L.; 3D Printed Electronics with Multi Jet Fusion. In Proceedings of Printing for Fabrication, San Francisco, Calif., USA, Sep. 29-Oct. 3, 2019.
16. Yokoyama, Y.; Hiji, N.; Takahasji, T.; Application of Attribute Information of Voxel-Based 3D Data Format FAV for Metamaterials Structure Design. In Proceedings of Printing for Fabrication, San Francisco, Calif., USA, Sep. 29-Oct. 3, 2019.
17. Seifi, M.; Salem, A.; Beuth, J.; Harrysson, O.; Lewandowski, J. J.; Overview of Materials Qualification Needs for Metal Additive Manufacturing. JOM 2016, 68(3), 747-64.
18. Collins, P. C.; Brice, D. A.; Samimi, P.; Ghamarian, I.; Fraser, H. L.; Microstructural Control of Additively Manufactured Materials. Annu. Rev. Mater. Res. 2016, 46, 63-91.
19. Lewandowski, J. J.; Seifi, M.; Metal Additive Manufacturing: A Review of Mechanical Properties. Annu. Rev. Mater. Res. 2016, 46, 151-86.

What is claimed is:

1. A method of additive manufacturing, the method comprising:
receiving an input signal, which is a representation of a composite geometry that is computed as a function of a primary geometry and a secondary geometry;
producing a feedback signal as a function of a melt pool size at a given site-specific location of multiple site-specific locations of a part being manufactured by an additive manufacturing system;
controlling at least one of a power control parameter of a laser-equipped print head, translation rate parameter of a drive subsystem, or feedstock rate parameter of a material feed subsystem dynamically as a function of at least an actuating error signal that represents a difference between the input signal and the feedback signal to enable the additive manufacturing system to produce a customized melt pool size or shape for the given site-specific location of the multiple site-specific locations to produce a part that, in a manufactured state, substantially matches the composite geometry.

2. The method of claim 1 further comprising:
sensing a temperature of the part at a proximal location to a site-specific location, at a distal location from the site-specific location, or a combination thereof; and
controlling at least one of the power control parameter, translation rate parameter, or feedstock rate parameter dynamically further as a function of the temperature sensed.

3. The method of claim 1 wherein producing the feedback signal includes capturing an image of the melt pool and extracting from the image a measure of at least one of size or shape of the melt pool.

4. The method of claim 1 further comprising regulating the translation rate parameter at a constant level while controlling at least one of the power control parameter or the feedstock rate parameter during translation of the print head.

5. The method of claim 1 further comprising applying non-linear control at the given site-specific location to produce a custom surface profile at the given site-specific location, the non-linear control applied based upon values derived from machine instructions including at least one of a lookup table, a G-code representation, a voxel representation, list instructions, or a command-line interface.

6. The method of claim 1 further comprising controlling the translation rate parameter to cause the drive subsystem to translate the print head with respect to the part, to translate the part with respect to the print head, or to translate both the print head and the part with respect to a common reference point or relative to each other.

7. The method of claim 1 further comprising controlling the feedstock rate parameter to cause the material feed subsystem to direct feedstock material to the part at the site-specific locations along a first and a second dimension, at a given layer defined along a third dimension.

8. The method of claim 1 further comprising computing the composite geometry based on an operation involving a first matrix describing the primary geometry and a second matrix describing the secondary geometry.

9. An additive manufacturing system comprising:
a laser-equipped print head configured to direct energy to a print head part, the energy of sufficient power to melt a material at site-specific locations of the part, the power adjustable via a laser power module according to a power control parameter;
a drive subsystem configured to cause a translation between the print head and the part, the translation adjustable according to a translation rate parameter;
a material feed subsystem configured to direct feedstock material to the part at the site-specific locations to be irradiated by the directed energy of the laser-equipped print head, the feedstock material output adjustable according to a feedstock rate parameter; and
a closed-loop feedback control subsystem including a comparison unit, controller, and melt pool sensor, the comparison unit configured (i) to receive (a) an input signal that is a representation of a composite geometry of a primary geometry and a secondary geometry that the part is to match substantially in a manufactured state at least at multiple site-specific locations and (b) a feedback signal provided by the melt pool sensor that is a function of size or shape of a melt pool at a given site-specific location of the multiple site-specific locations and (ii) to output an actuating error signal that represents a difference between the input signal and the feedback signal, the controller configured to control at least one of the power control parameter, translation rate parameter, or feedstock rate parameter dynamically as a function of the actuating error signal to enable the additive manufacturing system to produce a customized melt pool size or shape for the given site-specific location of the multiple site-specific locations to produce the part such that the part, in a manufactured state, substantially matches the composite geometry.

10. The system of claim 9 further comprising at least one additional sensor configured (i) to sense a temperature of the part at a proximal location to a site-specific location, at a distal location from the site-specific location, or at a combination thereof, and (ii) to provide a respective sensor signal according to a temperature sensed by the at least one additional sensor; and wherein the controller is further configured (i) to receive the respective sensor signal and (ii) to control at least one of the power control parameter, translation rate parameter, or feedstock rate parameter dynamically further as a function of the temperature sensed.

11. The system of claim 9 wherein the melt pool sensor includes a thermal or visible-light camera or a combination thereof.

12. The system of claim 9 wherein the secondary geometry is one of multiple secondary geometries.

13. The system of claim 9 wherein the controller is configured to regulate the translation rate parameter at a constant level while controlling at least one of the power control parameter or the feedstock rate parameter during translation of the print head.

14. The system of claim 9 wherein the controller is configured to apply non-linear control at the given site-specific location to produce a custom surface profile at the given site-specific location, the non-linear control applied based upon values derived from machine instructions including at least one of a lookup table, a G-code representation, a voxel representation, list instructions, or a command-line interface.

15. The system of claim 9 wherein the drive subsystem is configured to cause a translation between the print head and the part by translating the print head with respect to the part, by translating the part with respect to the print head, or by translating both the print head and the part with respect to a common reference point or relative to each other.

16. The system of claim 9 wherein the material feed subsystem is configured to direct feedstock material to the part at the site-specific locations along a first and a second dimension, at a given layer defined along a third dimension.

17. The system of claim 9 wherein the controller resides between an output node of the comparison unit and an input node of at least one of the laser power module, the drive subsystem, or the material feed subsystem.

18. The system of claim 9 further comprising a composite geometry calculation module configured to calculate the composite geometry based on an operation involving a first matrix describing the primary geometry and a second matrix describing the secondary geometry and to output the composite geometry as a representation thereof to the comparison unit.

19. A system for site-specific, closed-loop melt pool size control in metal additive manufacturing, the system comprising:
a laser-based print head configured to manufacture metal objects in an additive fashion;
a holder for holding a metal object while it is being manufactured using the laser-based print head;
a camera to image in real-time a melt pool on an instant surface of the metal object while it is being manufactured; and
a controller configured to perform, for a plurality of sites of the instant surface of the metal object, operations comprising:
obtaining an indication of a current site of the plurality of sites, the melt pool occupying at least a portion of a surface of the current site,
accessing a predetermined mapping of target laser-power levels to sites of the instant surface to establish a target laser-power level for the current site,
obtaining an instant laser-power level and comparing it with the target laser-power level for the current site,
if the instant and target laser-power levels differ from each other by more than a predetermined power offset, then setting the laser-power level to the target laser-power level for the current site,
accessing a predetermined mapping of target melt pool sizes to sites of the instant surface to establish a target melt pool size for the current site,
receiving images of the melt pool from the camera,
determining, based on the received images of the melt pool, an instant melt pool size and comparing it with the target melt pool size for the current site, and
if the instant and target melt pool sizes differ from each other by more than a predetermined size offset, then adjusting the laser-power level for the current site to a level corresponding to the target melt pool size.

20. The system of claim 19 wherein the predetermined mapping of target laser-power levels to sites of the instant surface is based on at least one of a lookup table, a G-code representation, a voxel representation, list instructions, or a command-line interface.

21. The system of claim 19 wherein the predetermined mapping of target melt pool sizes to sites of the instant surface is based on at least one of a lookup table, a G-code representation, a voxel representation, list instructions, or a command-line interface.

22. The system of claim 19 wherein the system is configured for embossing a secondary geometry on a primary geometry of the metal part.

23. The system of claim 19 wherein the system is configured for metal big-area additive manufacturing.
